(19) United States
(12) Patent Application Publication
(10) Pub. No.: US 2021/0155288 A1
(43) Pub. Date: May 27, 2021

(54) VEHICLE INFORMATION PROCESSING DEVICE

(71) Applicant: ISUZU MOTORS LIMITED, Shinagawa-ku, Tokyo (JP)

(72) Inventor: Shuuichi TAKANO, Fujisawa-shi, Kanagawa (JP)

(21) Appl. No.: 16/627,716

(22) PCT Filed: Jun. 15, 2018
(86) PCT No.: PCT/JP2018/022906

§ 371 Date: Dec. 30, 2019

(30) Foreign Application Priority Data
Jun. 30, 2017 (JP) 2017-128999

(51) Int. Cl. B62D 15/02; G06K 9/00; B62D 6/04; B62D 5/04

(52) U.S. Cl. CPC B62D 15/025; G06K 9/00845; B62D 5/04; B62D 6/04; B62D 15/029; G06K 9/00798

(57) ABSTRACT

This vehicle information processing device is provided with a steering assistance unit which assists steering by a driver driving a vehicle to operate a steering mechanism such that the vehicle travels while being maintained in a lane in which the vehicle is traveling, a detection unit which detects a physical quantity which changes in accordance with a change in a component provided in the steering mechanism when the steering mechanism works, and a notification unit which, when the steering assistance unit operates the steering mechanism based on an operation instruction for instructing the vehicle to travel while being maintained in a lane in which the vehicle is travelling, issues a notification of state information in a case where the physical quantity detected by the detection unit is outside a reference range determined by the operation instruction.

### TECHNICAL FIELD

The present disclosure relates to a vehicle information processing device.

### BACKGROUND ART

Patent literature 1 discloses a technology in which inclination of a head above a neck of a driver relative to a body below the neck of the driver is detected based on an image of a driver seat imaged by a camera mounted on a vehicle, and thus whether the driver is in a non-operable state can be detected.

### CITATION LIST

### Patent Document

Patent Literature 1: JP-A-2016-9255

### SUMMARY OF THE INVENTION

### Technical Problem

When the driver is inclined forward, the inclination of the head of the driver relative to the body does not change. Therefore, in the technology described in Patent Literature 1, when the driver is inclined forward, an abnormal state where it is difficult for the driver to drive the vehicle may be confused with a special state such as a state where the driver is taking an object that felt to the feet or a state where the driver is adjusting a position of the seat, and the state of the driver may be erroneously determined.

An object of the present disclosure is to provide a vehicle information processing device by which accuracy of estimating a state of a driver can be improved.

### Solution to Problem

A vehicle information processing device according to the present disclosure includes:

a steering assistance unit that assists steering by a driver who drives a vehicle to operate a steering mechanism to operate such that the vehicle travels while being maintained in a lane in which the vehicle is traveling;

a detection unit that detects a physical quantity which changes in accordance with a change in a component provided in the steering mechanism when the steering mechanism works; and

a notification unit that, when the steering assistance unit operates the steering mechanism based on an operation instruction for instructing the vehicle to travel while being maintained in a lane in which the vehicle is traveling, issues a notification of state information in a case where the physical quantity detected by the detection unit is outside a reference range determined by the operation instruction.

The detection unit may detect a displacement of a component provided in the steering mechanism, and the notification unit may issue a notification of state information in a case where an absolute value of a difference between the displacement detected by the detection unit and a target displacement, which is a displacement necessary for the vehicle to travel while being maintained in a lane in which the vehicle is traveling, is larger than a predetermined displacement threshold.

The detection unit may detect a force applied to a component provided in the steering mechanism, and the notification unit may issue a notification of state information in a case where a force applied to the component which is detected by the detection unit is outside a reference range determined by the operation instruction.

For example, the notification unit may issue a notification of state information after a predetermined period of time elapses since the physical quantity becomes outside the reference range.

The detection unit may detect a lane in which the vehicle is traveling, and the notification unit may issue a notification of state information when it is determined that the vehicle deviates from the lane.

### Advantageous Effects of the Invention

According to the vehicle information processing device of the present disclosure, the accuracy of estimating the state of the driver can be improved.

### BRIEF DESCRIPTION OF THE DRAWINGS

FIG. 1 is a diagram illustrating an outline of operation of a vehicle information processing device.

FIG. 2A is a schematic diagram assuming that a driver is driving in a normal state.

FIG. 2B is a graph schematically illustrating a relationship between a necessary steering angle necessary for lane maintaining and a detected current steering angle, when the driver is driving in the normal state.

FIG. 2C is a schematic diagram assuming that the driver is in an abnormal state of being difficult to drive the vehicle.

FIG. 2D is a graph schematically illustrating a relationship between a necessary steering angle necessary for the lane maintaining and a detected current steering angle, when the driver is in the abnormal state.

FIG. 3 is a diagram showing a functional configuration of the vehicle information processing device according to the embodiment.

FIG. 4A is a graph illustrating a relationship between a steering angle and torque.

FIG. 4B is a graph illustrating a relationship between a steering angle and torque.

FIG. 5 is a flowchart illustrating processing of issuing a notification of state information.

FIG. 6 is a flowchart illustrating processing of issuing a notification of state information when steering torque is detected.

FIG. 7A is a graph illustrating a relationship between a value of target steering torque and a value of actually detected steering torque.

FIG. 7B is a graph illustrating a relationship between a value of target steering torque and a value of actually detected steering torque.

FIG. 8A is a diagram illustrating a relationship between steering torque and a steering angle.

FIG. 8B is a diagram illustrating a relationship between steering torque and a steering angle.

### DESCRIPTION OF EMBODIMENTS

### Outline of Embodiment

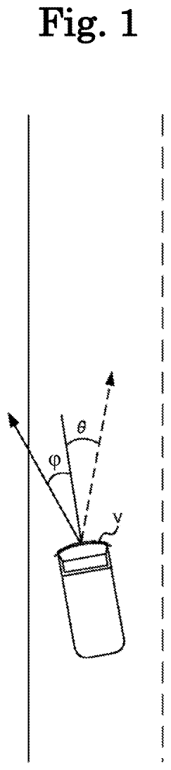

An outline of driving assistance performed by a vehicle information processing device mounted on a vehicle V will be described with reference to FIG. 1. FIG. 1 is a diagram illustrating an outline of operation of the vehicle information processing device. In FIG. 1, it is assumed that the vehicle V is traveling on an expressway. The vehicle information processing device is a device for assisting steering by a driver who drives the vehicle V. The vehicle information processing device operates a steering mechanism of the vehicle V such that the vehicle V travels while being maintained in a lane in which the vehicle V is traveling.

When the vehicle V is about to deviate from the lane in which the vehicle V is traveling, the vehicle information processing device operates the steering mechanism such that the vehicle V travels while being maintained in the lane in which the vehicle V is traveling. In FIG. 1, it is assumed that the vehicle V is moving toward a left side of the lane, in which the vehicle V is traveling, at a steering angle φ, as indicated by a solid arrow. The vehicle information processing device operates the steering mechanism such that the vehicle V is directed toward a right side in the traveling direction thereof as indicated by a dashed arrow, that is, toward a center of the road in FIG. 1.

For example, the vehicle information processing device operates the steering mechanism such that a steering angle of the vehicle V is turned from the current steering angle φ to a necessary steering angle θ necessary for the vehicle V to travel while being maintained in the lane in which the vehicle V is traveling. Specifically, the vehicle information processing device rotates a motor attached to a steering shaft of the vehicle V such that the steering angle of the vehicle V is turned to the steering angle θ. In this way, the vehicle information processing device can move the vehicle V while making the vehicle V maintained in the lane without departing from the lane in which the vehicle V is traveling.

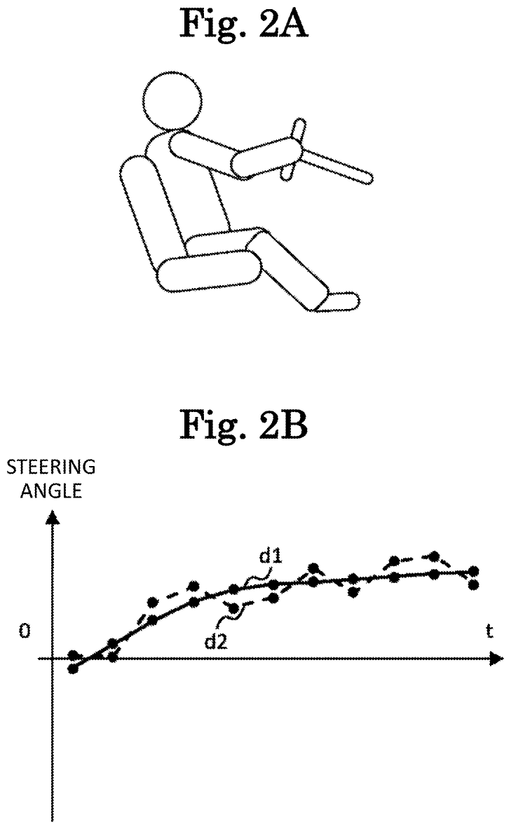

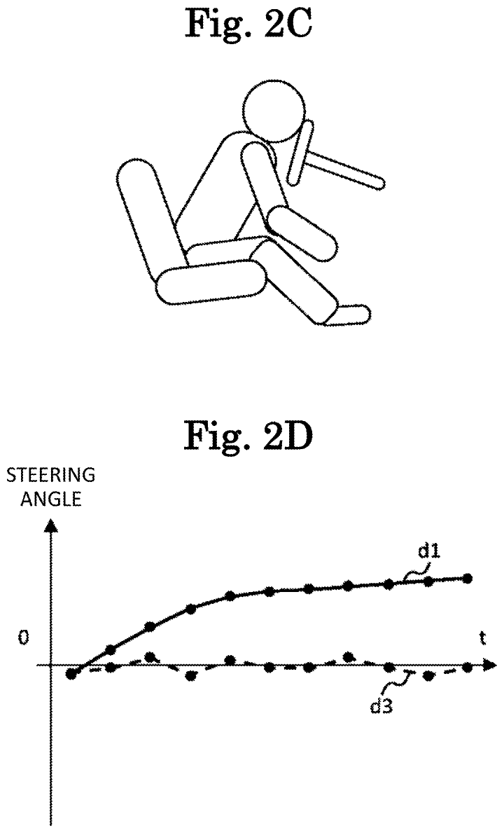

A relationship between the necessary steering angle θ necessary for the vehicle V to travel while being maintained in the lane in which the vehicle V is traveling (referred to as lane maintaining) and an actual steering angle φ′ that is actually detected when a driving assistance device causes the steering mechanism to operate will be described with reference to FIGS. 2A to 2D. FIGS. 2A to 2D are diagrams for illustrating the relationship between the necessary steering angle θ necessary for the lane maintaining and the detected current steering angle φ′.

FIG. 2A is a schematic diagram assuming that a driver is driving in a normal state. In FIG. 2A, the driver drives the vehicle V while holding the steering wheel and facing the front. FIG. 2B is a graph schematically illustrating a relationship between the necessary steering angle necessary for the lane maintaining and the detected current steering angle, when the driver is driving in the normal state. In FIG. 2B, the horizontal axis indicates a time point t, and the vertical axis indicates a steering angle. The steering angle is set to 0 degree when the vehicle V is traveling straight and the steering angle is positive in a turning direction, and is negative in a direction opposite to the turning direction. For example, when the vehicle V is turning to the right, a clockwise steering angle is positive and a counterclockwise steering angle is negative. Conversely, when the vehicle V is turning to the left, a counterclockwise steering angle is positive and a clockwise steering angle is negative.

In FIG. 2B, a solid line d1 is a graph on which necessary steering angles θ necessary for the lane maintaining are plotted, and a dashed line d2 is a graph on which the actually detected current steering angles φ′ are plotted. When the driver drives in the normal state, the solid line d1 and the dashed line d2 change substantially matching with each other.

FIG. 2C is a schematic diagram assuming that the driver is in an abnormal state of being difficult to drive the vehicle V. In FIG. 2C, the driver releases hands from the steering wheel, falls down to cover the steering wheel, and is in a state of being difficult to drive. FIG. 2D is a graph schematically illustrating a relationship between the necessary steering angle necessary θ for the lane maintaining and the detected current steering angle φ′, when the driver is in the abnormal state.

In FIG. 2D, the solid line d1 is a graph on which necessary steering angles θ necessary for the lane maintaining are plotted, and a dashed line d3 is a graph on which the actually detected current steering angles φ′ are plotted. When the driver is in the abnormal state, the solid line d1 and the dashed line d3 do not match. Since the vehicle information processing device cannot operate the steering mechanism when the driver falls down to cover the steering wheel, the actually detected current steering angle φ′ does not change even when the necessary steering angle θ necessary for the lane maintaining changes, and takes a substantially constant value.

When an absolute value of a difference between the necessary steering angle θ necessary for the lane maintaining and the actually detected current steering angle φ′ is greater than a predetermined displacement threshold, the vehicle information processing device determines that the vehicle V is in an abnormal state in which the steering angle of the vehicle V cannot be set to the necessary steering angle θ necessary for the lane maintaining. The predetermined displacement threshold may be determined by experiments using a room or a measurement error necessary for preventing a manufacturer of the vehicle V from erroneously determining the abnormal state.

When determining that the vehicle V is in an abnormal state, the vehicle information processing device issues a notification of the driver of state information indicating the abnormal state. The vehicle information processing device may notify the driver of the state information after a predetermined period of time elapses since the abnormal state is determined.

The predetermined period of time is a period of time necessary for preventing the vehicle information processing device from erroneously determining the state of the driver. The necessary time is preferably obtained by experiments by the manufacturer of the vehicle V, but may be determined by the vehicle information processing device based on the steering angle of the vehicle V, speed, and a width of the lane. For example, the vehicle information processing device creates a right triangle using a distance between a side surface of the vehicle V and a lane edge of the lane in which the vehicle V travels and the steering angle of the vehicle V, and sets and specifies a time for the vehicle V to deviate from the lane when the vehicle V is travelling at the speed v as the predetermined period of time. A specific value of the predetermined period of time is about 3 seconds when the vehicle is traveling at a speed of 72 km/h and turning to the left at an angle of 1 degree, for example, in a case where the vehicle V having a width of 2 m is traveling on a driving lane on an expressway having a width of 3.5 m and a distance from a left front wheel of the vehicle V to the lane edge is 1 m.

The necessary time may be determined using an inclination angle of the vehicle V with respect to the lane, and the inclination angle is specified by the vehicle information processing device analyzing a captured image captured by a camera mounted on the vehicle V. Specifically, the vehicle information processing device may create a right triangle using the inclination angle of the vehicle V with respect to the lane and the distance between the side surface of the vehicle V and the lane edge of the lane in which the vehicle V travels, and may set and specify a time for the vehicle V to deviate from the lane when the vehicle V is traveling at the speed v as the predetermined period of time.

When the vehicle information processing device determines that the vehicle V is in an abnormal state and the vehicle V deviates from the lane in which the vehicle was traveling, the vehicle information processing device may notify the driver of the state information even if the predetermined period of time has not elapsed. The vehicle information processing device notifies the driver of the state information by, for example, outputting sound from a speaker or displaying a display image on a display screen.

In a case where the vehicle information processing device regards that the driver of the vehicle V is in a state of being difficult to drive the vehicle V if the abnormal state continues even after the predetermined period of time for waiting elapses since the vehicle information processing device issues the notification of the state information, the vehicle information processing device may notify various devices of the vehicle V of the state information. For example, the vehicle information processing device notifies a speed control device that controls the speed of the vehicle V of the state information. When receiving the notification of the state information, the speed control device reduces the speed of the vehicle V. In this way, safety of the vehicle V can be improved.

As described above, the vehicle information processing device determines that the driver is in an abnormal state when the actually detected steering angle is smaller than the steering angle necessary for the lane maintaining. In this way, the vehicle information processing device can reduce confusion of a state where it is difficult for the driver to drive with a special state such as a state where the driver is taking an object that felt to the feet or a state where the driver is adjusting a position of the seat.

<Functional Configuration of Vehicle Information Processing Device 5 According to Embodiment>

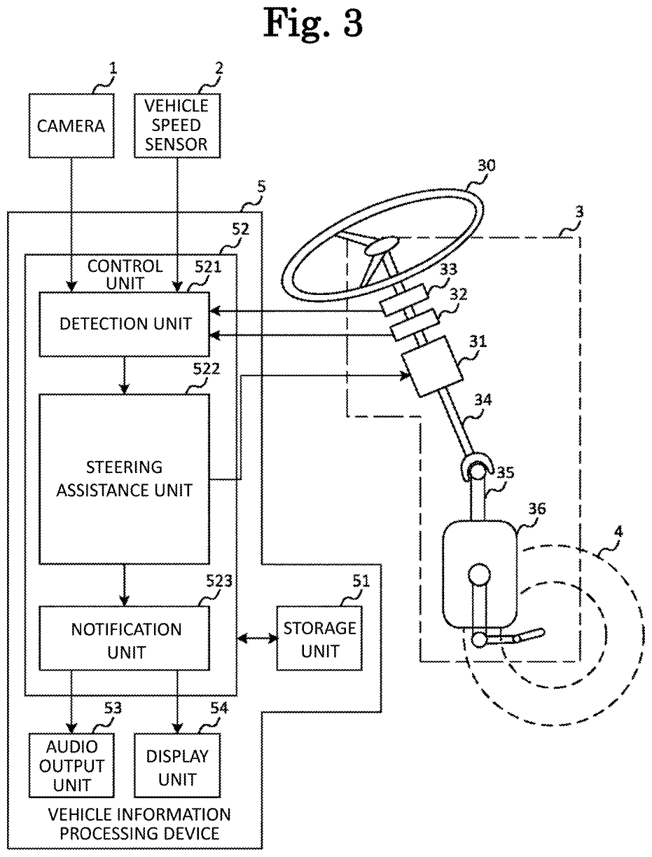

Hereinafter, an outline of the vehicle V according to the embodiment and a functional configuration of a vehicle information processing device 5 mounted on the vehicle V will be described with reference to FIG. 3. FIG. 3 is a diagram showing a functional configuration of the vehicle information processing device 5 according to the embodiment. The vehicle information processing device 5 according to the embodiment is preferably used for a large vehicle V such as a bus or a truck, but the present invention is not limited thereto. In the present embodiment, description will be made assuming that the vehicle V is a large vehicle V such as a bus or a truck. The vehicle V includes a camera 1, a vehicle speed sensor 2, a steering mechanism 3, steered wheels 4, and the vehicle information processing device 5.

The camera 1 captures the front of the vehicle V generates a captured image, and transmits the captured image to the vehicle information processing device 5. The vehicle speed sensor 2 detects a speed of the vehicle V and transmits the speed to the vehicle information processing device 5.

The steering mechanism 3 includes a steering wheel 30, a motor 31, an angle sensor 32, a torque sensor 33, a steering shaft 34, a stub shaft 35, and a power cylinder unit 36. The steering wheel 30 is a steering wheel for the driver to operate a steering angle of the vehicle V. The motor 31 is attached to the steering shaft 34, and applies assistance torque (steering assistance force) to the steering shaft 34 to assist the steering operation of the driver.

The angle sensor 32 is provided on the steering shaft 34, and detects an amount of rotation of the steering shaft 34 so as to detect a steering angle θ based on the amount of rotation. The angle sensor 32 transmits the detected steering angle θ to the vehicle information processing device 5. The torque sensor 33 is attached to the steering shaft 34 and detects steering torque applied to the steering shaft 34. The torque sensor 33 transmits the detected steering torque to the vehicle information processing device 5.

One end of the steering shaft 34 is connected to the steering wheel 30, and the other end thereof is connected to the stub shaft 35. One end of the stub shaft 35 is connected to the steering shaft 34, and the other end thereof is connected to an input shaft of the power cylinder 36. The steering shaft 34 and the stub shaft 35 transmit the steering torque applied to the steering wheel 30 to the power cylinder unit 36. The power cylinder unit 36 transmits, to the steered wheels 4, the steering torque applied to the steering wheel 30 in addition to a steering assistance force using hydraulic oil discharged from a hydraulic pump.

The vehicle information processing device 5 includes a storage unit 51, a control unit 52, an audio output unit 53, and a display unit 54. The storage unit 51 is, for example, a Read Only Memory (ROM) or a Random Access Memory (RAM). The storage unit 51 stores various programs for causing the control unit 52 to function.

The control unit 52 is a calculation resource including a processor (not shown) such as a Central Processing Unit (CPU). The control unit 52 implements functions of a detection unit 521, a steering assistance unit 522, and a notification unit 523 by executing the programs stored in the storage unit 51.

The detection unit 521 detects various types of information of the vehicle V. For example, the detection unit 521 detects a physical quantity that changes in accordance with a change in a component provided in the steering mechanism 3 when the steering mechanism 3 works. The physical quantity is, for example, a displacement of a component. Specifically, the detection unit 521 detects a displacement of each component provided in the steering mechanism 3. For example, the detection unit 521 detects an angular displacement of the steering shaft 34 by acquiring the steering angle θ detected by the angle sensor 32. For example, the detection unit 521 detects an amount of movement of a relay rod (not shown).

The physical quantity may be a force applied to the component. Specifically, the detection unit 521 detects a force applied to each component provided in the steering mechanism. For example, the detection unit 521 detects a force applied to the steering shaft 34 by acquiring the steering torque applied to the steering shaft 34 that is detected by the torque sensor 33. The detection unit 521 may detect a force applied to the power cylinder unit 36.

The detection unit 521 may detect an external environment of the vehicle V. For example, the detection unit 521 detects a lane in which the vehicle V is traveling. Specifically, the detection unit 521 detects a lane edge by applying a model of the lane edge to a captured image captured by the camera 1, and detects the lane in which the vehicle V is traveling using the detected lane edge. The detection unit 521 is not limited to the above, and may detect a lane in which the vehicle V is traveling using a known image analysis technology. The detection unit 521 notifies the steering assistance unit 522 of various types of information of the vehicle V and the external environment of the vehicle V. Specifically, the detection unit 521 notifies the steering assistance unit 522 of the displacement of the component, the force applied to the component, and the lane in which the vehicle V is traveling.

The steering assistance unit 522 assists the steering by the driver who drives the vehicle V to operate the steering mechanism 3 such that the vehicle V travels while being maintained in the lane in which the vehicle V is traveling. Specifically, the steering assistance unit 522 determines whether there is a possibility for the vehicle V of deviating from the lane in which the vehicle V is traveling, using the lane in which the vehicle V is traveling and which is detected by the detection unit 521, and the steering angle θ. When the steering assistance unit 522 determines that the vehicle V may deviate from the lane in which the vehicle is traveling, the steering assistance unit 522 notifies the notification unit 523 of alarm information indicating that the vehicle V may deviate from the lane in which the vehicle V is traveling. When it is determined that there is no input such as operation of the steering wheel 30 from the driver after notification of the alarm information, the steering assistance unit 522 generates an operation instruction for operating the steering mechanism 3 in order to make the vehicle V travel while being maintained in the lane in which the vehicle V is traveling. The steering assistance unit 522 controls the steering mechanism 3 to operate based on the operation instruction.

The operation instruction includes, for example, a target displacement that is a displacement of the steering mechanism 3 necessary for the vehicle V to travel while being maintained in the lane in which the vehicle V is traveling. The target displacement is, for example, a rotation angle of the steering shaft 34 necessary for setting the steering angle to a target steering angle for the lane maintaining from the current steering angle θ. The target displacement is, for example, an amount of movement of the relay rod necessary for setting the steering angle to the target steering angle for the lane maintaining from the current steering angle θ. If the vehicle V is a passenger vehicle and has a rack and pinion type steering system, the necessary displacement of the steering mechanism 3 may be a rotation angle of a pinion gear or an amount of movement of a rack.

The operation instruction may include, for example, magnitude of a force assumed to be applied to a component when the steering mechanism 3 works for the lane maintaining. The magnitude of the force assumed to be applied to the component may be determined in advance by the manufacturer of the vehicle V through experiments. The magnitude of the force applied to the component is, for example, an absolute value of the steering torque applied to the steering shaft 34 and the force applied to the power cylinder unit 36.

A specific method by which the steering assistance unit 522 causes the steering mechanism 3 to operate will be described. For example, the steering assistance unit 522 causes the steering mechanism 3 to operate by rotating the motor 31 based on the component displacement detected by the detection unit 521. Specifically, the steering assistance unit 522 rotates the motor 31 so as to obtain a necessary rotation angle. More specifically, the steering assistance unit 522 controls a voltage to be input to the motor 31 and a time for inputting the voltage.

In the present embodiment, the steering assistance unit 522 causes the steering mechanism 3 to operate by rotating the motor 31 attached to the steering shaft 34, but a control target of the steering assistance unit 522 is not limited thereto. For example, the steering assistance unit 522 may control the hydraulic pump that supplies the hydraulic oil to the power cylinder unit 36. For example, if the vehicle V is a passenger vehicle and has a rack and pinion type steering system, the steering assistance unit 522 may cause the steering mechanism 3 to operate by rotating a steering column, a pinion gear, or a motor attached to a rack.

The steering assistance unit 522 notifies the notification unit 523 of the displacement detected by the detection unit 521, the magnitude of the force detected by the steering assistance unit 522, and the target displacement.

The notification unit 523 issues a notification of the state information indicating that the driver is in an abnormal state of being difficult to drive the vehicle V. For example, when the steering assistance unit 522 causes the steering mechanism 3 to operate based on the operation instruction for instructing the vehicle V to travel while being maintained in the lane in which the vehicle V is traveling, the notification unit 523 issues a notification of the state information when the physical quantity detected by the detection unit 521 is outside a reference range determined by the operation instruction. Specifically, the notification unit 523 issues a notification of the state information when an absolute value of a difference between the displacement of the component detected by the detection unit 521 and the target displacement, that is a displacement necessary for the vehicle V to travel while being maintained in the lane in which the vehicle V is traveling is larger than a predetermined displacement threshold. More specifically, the notification unit 523 issues a notification of the state information indicating an abnormal state where the steering mechanism 3 cannot operate when an absolute value of a difference between the necessary steering angle θ necessary for the lane maintaining and the current steering angle φ′ that is a current steering angle detected by the detection unit 521, is larger than a predetermined displacement threshold.

The predetermined displacement threshold may be determined by the manufacturer of the vehicle V in consideration of a margin necessary for preventing erroneously determining the abnormal state where the steering mechanism 3 cannot operate. A specific value of the predetermined displacement threshold may be determined according to measurement accuracy of a sensor that detects the displacement. For example, measurement accuracy of the angle sensor 32 for measuring the angle of the steering shaft 34 used in the present embodiment is 0.1 degree.

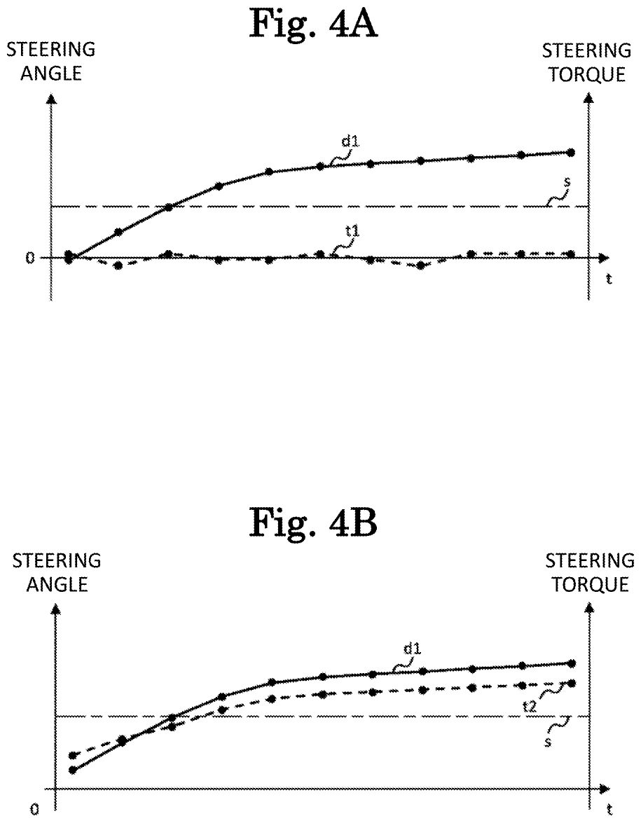

The notification unit 523 may issue a notification of the state information when a force applied to the component detected by the detection unit 521 is outside the reference range determined by the operation instruction. For example, the notification unit 523 issues a notification of the state information when the steering torque detected by the detection unit 521 is outside the reference range determined by the operation instruction. A relationship between the steering angle and the torque will be described with reference to FIGS. 4A and 4B. FIGS. 4A and 4B are graphs for illustrating the relationship between the steering angle and the torque.

In FIG. 4A, it is assumed that the driver is driving in a normal state as in FIG. 2A. In FIG. 4A, the horizontal axis indicates a time point t, a first vertical axis on the left indicates an angle, and a second vertical axis on the right indicates steering torque. In FIG. 4A, a solid line d is a graph in which the steering angles necessary for the lane maintaining are plotted, and a dashed line t1 is a graph in which the detected steering torque is plotted. When the driver is driving in a normal state, even if the necessary steering angle changes, the detected steering torque does not change greatly and takes a substantially constant value less than a predetermined threshold s. A range having a value being less than the predetermined threshold s is a reference range determined by the necessary steering angle included in the operation instruction.

In FIG. 4B, it is assumed that the driver is in an abnormal state of being difficult to drive the vehicle V as in FIG. 2C. In FIG. 4B, the solid line d1 is a graph in which the steering angles necessary for the lane maintaining are plotted, and a dashed line t2 is a graph in which the detected steering torque is plotted. When the driver is in an abnormal state, the steering torque changes to follow the necessary steering angles. This is because even if the steering assistance unit 522 tries to operate the steering mechanism 3, the driver is a resistance and the steering mechanism 3 cannot be moved. At this time, the detected steering torque is equal to or greater than the predetermined threshold s.

In this way, when the driver is in an abnormal state, the detection unit 521 can detect a resistance force against the operation of the steering mechanism 3. In the present embodiment, although the detection unit 521 detects the steering torque using the torque sensor 33, the detection unit 521 may detect the force applied to the power cylinder unit 36.

The reference range determined by the operation instruction may be determined according to the physical quantity detected by the detection unit 521. For example, when the detection unit 521 detects the displacement of the component of the steering mechanism 3 as the physical quantity, the reference range is a range determined by the target displacement with respect to the necessary steering angle, and a room and measurement error for prevent erroneously determining that the steering mechanism 3 cannot operate.

For example, when the detection unit 521 detects the magnitude of the force applied to the component of the steering mechanism 3 as the physical quantity, the reference range is a range that is equal to or greater a threshold with magnitude of a force assumed to be applied when the steering mechanism 3 works being set as a reference value. The reference value of the magnitude of the force assumed to be applied when the steering mechanism 3 works may be determined in advance by experiments, or may be determined according to the speed of the vehicle V. Specifically, if the reference value of the magnitude of the force is an absolute value of the steering torque, the higher the speed of the vehicle V is, the smaller the reference value is.

The notification unit 523 may issue a notification of the state information after a predetermined period of time elapses since the physical quantity becomes outside the reference range. The predetermined period of time is, as described above, a period of time necessary for preventing the state of the driver from being erroneously determined. In this way, it is possible to reduce the probability that the notification unit 523 issues a notification of a normal state of the driver as an abnormal state.

The notification unit 523 may issue a notification of the state information based on the physical quantity accumulated for a predetermined period of time. For example, the notification unit 523 issues a notification of the state information when a sum, in a predetermined period of time, of a difference between a target value determined by the operation instruction and the physical quantity detected by the detection unit 521 after the steering mechanism 3 works in response to the operation instruction is larger than a predetermined integration threshold. The target value determined by the operation instruction is, for example, a target displacement. The predetermined integration threshold is a reference value necessary for preventing the notification unit 523 from erroneously determining the state of the driver. The reference value may be determined by the manufacturer of the vehicle V through experiments.

When the vehicle V deviates from the lane in which the vehicle V was traveling, it is estimated that the driver is in an abnormal state of being difficult to drive the vehicle V. For this reason, when it is determined that the vehicle has deviated from the lane in which the vehicle was traveling, the notification unit 523 issues a notification of the state information. When it is determined that the vehicle has deviated from the lane in which the vehicle was traveling, the notification unit 523 may issue a notification of the state information even if the predetermined period of time does not elapse.

The notification unit 523 notifies each unit of the vehicle information processing device 5 of the state information. For example, the notification unit 523 notifies the audio output unit 53 of the state information as audio data. The audio output unit 53 is, for example, a speaker that outputs, as sound, the state information notified as sound data. Specifically, the audio output unit 53 outputs a voice “Deviated from the lane. Please drive the vehicle to the center of the lane.”.

The notification unit 523 notifies the display unit 54 of the state information as an image or text data. The display unit 54 is, for example, a display that is provided on a meter panel and that displays the state information notified as an image or text data on a display screen. The display unit 54 displays an icon or an image indicating that the vehicle deviates from the lane together with a text “Deviated from the lane. Please drive the vehicle to the center of the lane.”. In this way, the driver who drives the vehicle V can receive notification of the state information.

The notification unit 523 may include a touch panel or a switch. For example, the notification unit 523 receives an instruction to cancel the notification of the state information or receives information indicating that the driver is in a normal state via the touch panel or the switch. In this way, the driver can input that an own state is normal to the notification unit 523.

The vehicle V may include an emergency stop device that stops the vehicle V or a communication device that can communicate with an external device. For example, the notification unit 523 transmits state information indicating an abnormal state to the emergency stop device. When receiving the notification of the state information indicating the abnormal state, the emergency stop device controls the vehicle V to stop. Specifically, the emergency stop device blinks a hazard lamp and controls the vehicle V to move to the shoulder while decelerating to stop.

The notification unit 523 may notify the communication device of state information indicating an abnormal state. When receiving the notification of the state information indicating the abnormal state, the communication device transmits the state information indicating the abnormal state to a predetermined external device. The predetermined external device is, for example, a communication terminal set by a police and related organizations thereof, a medical institution such as a hospital, an organization that manages and operates an expressway, or a driver.

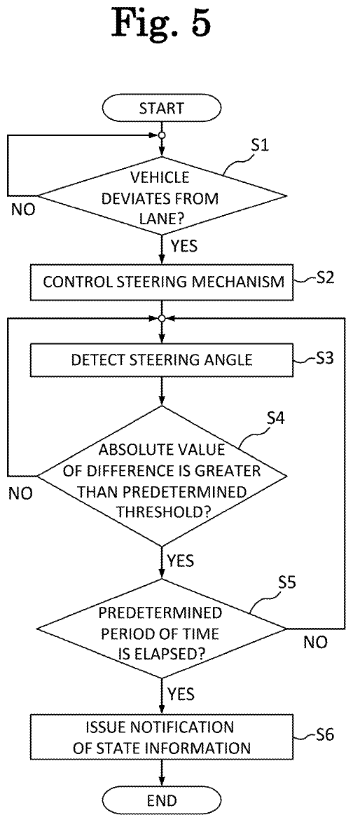

Hereinafter, processing of issuing a notification of the state information performed by the vehicle information processing device 5 will be described with reference to FIG. 5. FIG. 5 is a flowchart illustrating processing of issuing the notification of the state information. In the flowchart of FIG. 5, description is made assuming that the detection unit 521 detects a lane in which the vehicle V travels.

First, the steering assistance unit 522 determines whether the vehicle V deviates from the lane (step S1). If it is determined that the vehicle V does not deviate from the lane, the steering assistance unit 522 waits and the processing returns to step S1. If it is determined that the vehicle V deviates from the lane, the steering assistance unit 522 controls the steering mechanism 3 such that the steering angle of the vehicle V is turned to the necessary steering angle necessary for the lane maintaining (step S2). The detection unit 521 detects a current steering angle that is a steering angle of the vehicle V after the steering mechanism 3 is controlled (step S3).

The steering assistance unit 522 notifies the notification unit 523 of the necessary steering angle necessary for the lane maintaining and the current steering angle detected by the detection unit 521. The notification unit 523 determines whether an absolute value of a difference between the current steering angle and the necessary steering angle is larger than a predetermined displacement threshold (step S4). If the notification unit 523 determines that the absolute value of the difference is equal to or less than the predetermined displacement threshold (No in step S4), the processing returns to step S3, and the detection unit 521 detects an angle of the steering shaft 34. If the notification unit 523 determines the absolute value of the difference is larger than the predetermined displacement threshold (Yes in step S4), the notification unit 523 determines whether a predetermined period of time elapses since it is determined that the absolute value of the difference is greater than the predetermined displacement threshold (step S5).

If it is determined that the predetermined period of time is not elapsed since the notification unit 523 determines that the absolute value of the difference is greater than the predetermined displacement threshold (No in step S5), the processing returns to step S3, the detection unit 521 detects the angle of the steering shaft 34. If it is determined that the predetermined period of time is elapsed since the notification unit 523 determines that the absolute value of the difference is greater than the predetermined displacement threshold (Yes in step S5), the state information is notified to the driver (step S6).

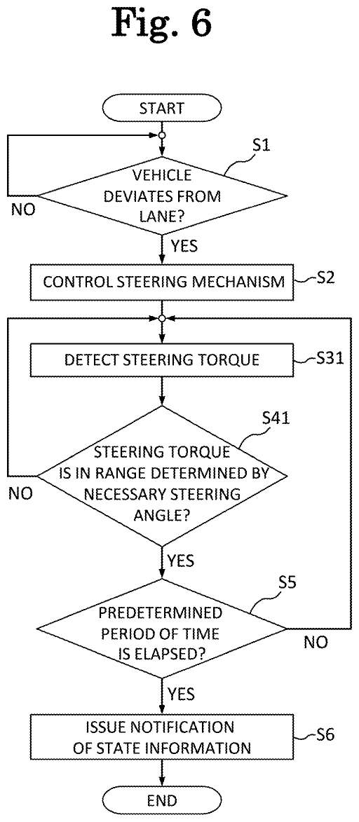

In the description of FIG. 5, although the detection unit 521 detects the steering angle, the detection unit 521 may detect the steering torque. FIG. 6 is a flowchart illustrating processing of issuing a notification of the state information when steering torque is detected. FIG. 6 is a flowchart illustrating processing in which step S31 is performed instead of step S3 in FIG. 5 and step S41 is performed instead of step S4, and since the operation other than step S31 and step S41 are similar with those in the flowchart of FIG. 5, description thereof will be omitted.

The detection unit 521 detects a current steering torque that is a steering torque of the vehicle V after the steering mechanism 3 is controlled (step S31). The steering assistance unit 522 notifies the notification unit 523 of the necessary steering angle necessary for the lane maintaining and the current steering torque detected by the detection unit 521. The notification unit 523 determines whether the steering torque is within a range determined by the necessary steering angle (step S4). If the notification unit 523 determines that the steering torque is within the range determined by the necessary steering angle (No in step S41), the processing returns to step S31, and the detection unit 521 detects the steering torque.

If the notification unit 523 determines that the steering torque is outside the range determined by the necessary steering angle (Yes in step S41), the notification unit 523 determines whether a predetermined period of time elapses since it is determined that the steering torque is outside the range determined by the necessary steering angle (step S5). In this way, the notification unit 523 may determine whether to issue a notification of the state information based not only on the steering angle but also on the steering torque. Further, the detection unit 521 may detect other physical quantities but not only the steering angle or the steering torque and the notification unit 523 may determine whether to issue a notification of the state information based on the physical quantities detected by the detection unit 521.

### Effect of Embodiment

As described above, when the steering assistance unit 522 causes the steering mechanism 3 to operate for the lane maintaining, the notification unit 523 determines an abnormal state that the steering mechanism 3 cannot operate when the physical quantity detected by the detection unit 521 is outside the reference range. If the abnormal state is determined, the vehicle information processing device 5 can estimate that the driver is in a state of being difficult to drive the vehicle V, for example, falling down to cover a steering wheel. Therefore, the vehicle information processing device 5 can reduce confusion of a state where it is difficult for the driver to drive the vehicle with a special state such as a state where the driver is taking an object that felt to the feet or a state where the driver is adjusting a position of the seat, so that the accuracy of estimating the state of the driver can be improved.

The present disclosure has been described using the embodiment, but the technical scope of the present disclosure is not limited to the scope described in the above-described embodiment, and various modifications and changes can be made within the scope thereof. For example, a specific embodiment of distributing and integrating devices is not limited to the above embodiment, and all or a part thereof may be configured to be functionally or physically distributed and integrated in any unit. New embodiments generated from any combination of a plurality of embodiments are also included in embodiments of the present disclosure. Effects of the new embodiments generated from the combinations include effects of the original embodiments.

(First Modification)

In the above description, the vehicle information processing device 5 operates the steering mechanism 3 of the vehicle V to control the steering angle of the vehicle V. The vehicle information processing device 5 may control the steering torque instead of the steering angle. Specifically, the steering assistance unit 522 operates the steering mechanism 3 such that the steering torque is turned into the target steering torque. When the steering assistance unit 522 operates the steering mechanism 3 such that the steering torque is turned into the target steering torque, it is not recommended to operate the steering mechanism 3 to forcibly change the steering angle regardless of the operation of the driver in order to provide a room for accepting the operation of the driver. Therefore, the value of the steering torque included in the operation instruction and the value of the steering torque detected by the detection unit 521 do not always match.

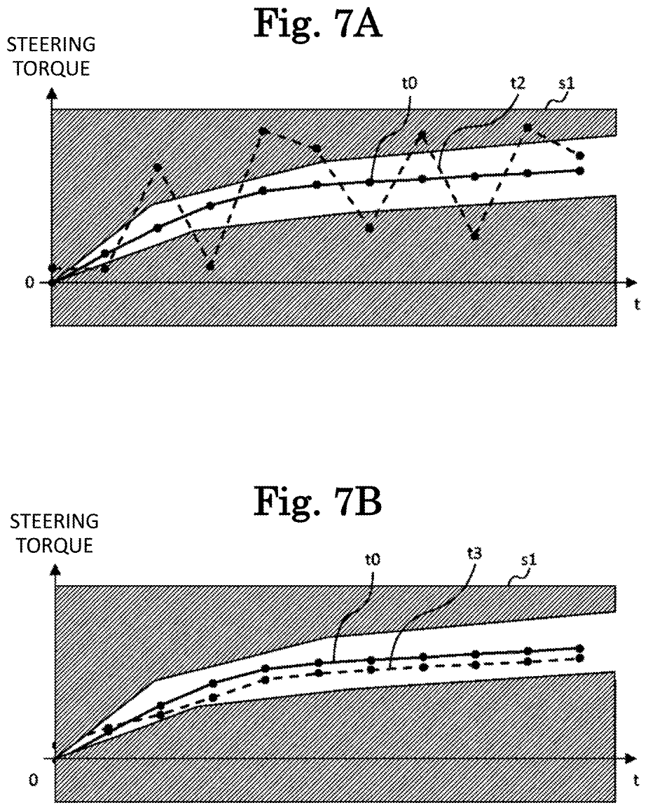

The steering assistance unit 522 controls, for example, rotation of the motor 31 so as to achieve the target steering torque. FIGS. 7A and 7B are graphs illustrating a relationship between a value of the target steering torque and a value of the actually detected steering torque. In FIG. 7A, it is assumed that the driver is driving in a normal state as in FIG. 2A. In FIG. 7A, the horizontal axis indicates a time point t, and the vertical axis indicates steering torque. In FIG. 7A, a solid line t0 is a graph in which the steering torque necessary for the lane maintaining is plotted, and a dashed line t2 is a graph in which the detected steering torque is plotted. An area covered with diagonal lines is a reference range s1 determined by the necessary steering torque.

In FIG. 7A, relative to the solid line t0 indicating the target steering torque, the detected steering torque has the same overall tendency (In FIG. 7A, the tendency is to increase over time), but varies vertically. This is because, for the detected steering torque, a change in steering torque due to a steering operation by the driver is also detected.

In FIG. 7B, it is assumed that the driver is in an abnormal state of being difficult to drive the vehicle V as in FIG. 2C. In FIG. 7B, a solid line t0 is a graph in which the steering torque necessary for the lane maintaining is plotted, and a dashed line t3 is a graph in which the detected steering torque is plotted. When the driver is in an abnormal state, since the steering operation by the driver is not detected, the detected steering torque t3 tends to substantially match the necessary steering torque t.

In this way, when the steering assistance unit 522 causes the steering mechanism 3 to operate for the lane maintaining, the notification unit 523 can estimate that the driver is in a state of being difficult to drive the vehicle V if the steering torque detected by the detection unit 521 is outside the reference range. In this way, the vehicle information processing device 5 can determine that the driver is in an abnormal state of being difficult to drive such as falling down to cover the steering wheel or removing the hand from the steering wheel.

(Second Modification)

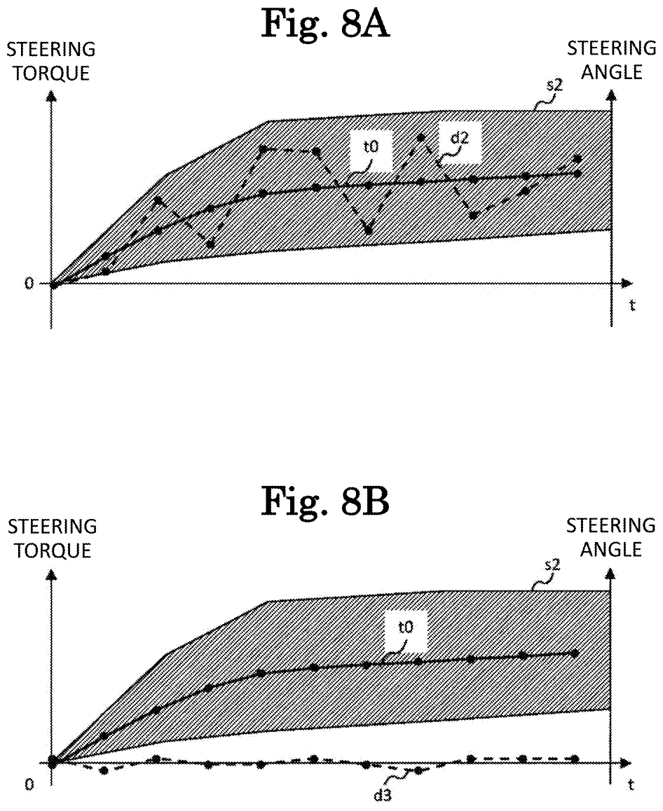

In the first modification, the detection unit 521 detects the steering torque, but the present invention is not limited thereto, and the detection unit 521 may detect the steering angle of the vehicle V. For example, the steering assistance unit 522 operates the steering mechanism 3 to control the steering torque such that the steering angle of the vehicle V is turned into the target steering angle, and the detection unit 521 detects the steering angle when the steering mechanism 3 works. FIGS. 8A and 8B are graphs for illustrating the relationship between the steering torque and the steering angle.

In FIG. 8A, it is assumed that the driver is driving in a normal state as in FIG. 2A. In FIG. 8A, the horizontal axis indicates a time point t, a first vertical axis on the left indicates steering torque, and a second vertical axis on the right indicates a steering angle. In FIG. 8A, a solid line t0 is a graph in which the steering torque necessary for the lane maintaining is plotted, and a dashed line d2 is a graph in which the detected steering angles are plotted. When the driver is driving in a normal state, the steering angle varies depending on operation of the driver, but tends to follow the steering torque. At this time, the steering angle changes within the reference range (s) determined by the operation instruction.

In FIG. 8B, it is assumed that the driver is in an abnormal state of being difficult to drive the vehicle V as in FIG. 2C. In FIG. 8B, a solid line t0 is a graph in which the steering angles necessary for the lane maintaining are plotted, and a dashed line d3 is a graph in which the detected steering angles are plotted. For example, when the driver is in an abnormal state such as falling down to cover the steering wheel, the steering angle shows a constant value regardless of changes in the steering torque. At this time, the steering angle changes outside the reference range (s1) determined by the operation instruction.

In this way, when the driver falls down to cover the steering wheel, the detection unit 521 detects a constant steering angle. Therefore, the notification unit 523 issues a notification of the state information when the steering angle is out of the reference range with respect to the target steering torque. The notification unit 523 may issue a notification of the state information when the steering angle is constant with respect to the target steering torque. In this way, since the notification unit 523 can also estimate that the driver is in a state of being difficult to drive the vehicle V when the driver covers the steering wheel or removes hands from the steering wheel, the accuracy of estimating the state of the driver can be improved.

The present application is based on the Japanese Patent Application (P2017-128999) filed on Jun. 30, 2017, contents of which are incorporated herein by reference.

### INDUSTRIAL APPLICABILITY

The vehicle information processing device of the present disclosure is useful in a point that the accuracy of estimating the state of the driver can be improved.

### LIST OF REFERENCE NUMERALS

1 camera
2 vehicle speed sensor
3 steering mechanism
4 steered wheel
5 vehicle information processing device
30 steering wheel
31 motor
32 angle sensor
33 torque sensor
34 steering shaft
35 stub shaft
36 power cylinder unit
51 storage unit
52 control unit
53 audio output unit
54 display unit
521 detection unit
522 steering assistance unit
523 notification unit

1. A vehicle information processing device, comprising:
a steering assistance unit that assists steering by a driver who drives a vehicle to operate a steering mechanism such that the vehicle travels while being maintained in a lane in which the vehicle is traveling;
a detection unit that detects a physical quantity which changes in accordance with a change in a component provided in the steering mechanism when the steering mechanism works; and
a notification unit that, when the steering assistance unit operates the steering mechanism based on an operation instruction for instructing the vehicle to travel while being maintained in a lane in which the vehicle is traveling, issues a notification of state information in a case where the physical quantity detected by the detection unit is outside a reference range determined by the operation instruction.

2. The vehicle information processing device according to claim 1,
wherein the detection unit detects a displacement of a component provided in the steering mechanism, and
the notification unit issues a notification of state information in a case where an absolute value of a difference between the displacement detected by the detection unit and a target displacement, which is a displacement necessary for the vehicle to travel while being maintained in a lane in which the vehicle is traveling, is larger than a predetermined displacement threshold.

3. The vehicle information processing device according to claim 1,
wherein the detection unit detects a force applied to a component provided in the steering mechanism, and
the notification unit issues a notification of state information in a case where a force applied to the component which is detected by the detection unit is outside a reference range determined by the operation instruction.

4. The vehicle information processing device according to claim 1,
wherein the notification unit issues a notification of state information after a predetermined period of time elapses since the physical quantity becomes outside the reference range.

5. The vehicle information processing device according to claim 1,
wherein the detection unit detects a lane in which the vehicle is traveling, and
the notification unit issues a notification of state information when it is determined that the vehicle deviates from the lane.
